(19) United States
(12) Patent Application Publication
(10) Pub. No.: US 2005/0066279 A1
(43) Pub. Date: Mar. 24, 2005

(54) Stop motion capture tool

(76) Inventors: Jeffrey LeBarton, Burbank, CA (US); Chava LeBarton, Burbank, CA (US); John Christopher Williams, Los Angeles, CA (US)

Correspondence Address: GREENBERG TRAURIG LLP, 2450 COLORADO AVENUE, SUITE 400E, SANTA MONICA, CA, 90404, US

(21) Appl. No.: 10/897,512

(22) Filed: Jul. 23, 2004

Related U.S. Application Data
(60) Provisional application No. 60/481,128, filed on Jul. 23, 2003.

(51) Int. Cl. G11B 27/00; G06F 3/00

(52) U.S. Cl. 715/723; 715/724; 715/725; 715/726; 715/732

(57) ABSTRACT

The present disclosure therefore provides a complete software application for creating stop motion animations, including capture, sequencing, and playback of single frame images, in addition to the ability to record voice and music, and insert audio such as sound tracks and sound effects. The present disclosure furthermore provides a system and method for teaching animation principles in an effective way. The present disclosure in not simply a stop motion capture tool. It is a teaching environment, for both students and instructors.

### RELATED APPLICATIONS

This application claims the priority date of U.S. Provisional Application No. 60/481,128 entitled “Stop Motion Capture Tool” filed on Jul. 23, 2003, the contents of which is incorporated by reference in its entirety.

### BACKGROUND

1. Field

The disclosure relates to new systems and methods of teaching animation principles and techniques and for facilitating the creation of animations by the non-professional general public. More specifically, the present disclosure relates to software for teaching and creating stop motion animations.

2. General Background and State of the Art

Stop motion capture is a technique used to create films or animations. Stop-motion animations are created by placing an object, taking a picture of it, moving the object, taking another picture, and then repeating that process over and over. Stop motion capture is also used to create films or animations by placing one drawing of a sequence of drawings, taking a picture of it, placing the next drawing from the sequence, taking another picture, and then repeating that process over and over.

This is traditionally hard to do because you generally can't see the result of your animation until after you've shot the whole thing, and there's no easy way to go back and edit just one piece of it.

Stop motion animation is a technique that can be used to make still objects come to life. For example, clay figures, puppets and cutouts may be used, and moved slightly, taking images with every movement. When the images are put together, the figures appear to move.

Many older movie cameras include the ability to shoot one frame at a time, rather than at full running speed. Each time you click the camera trigger, you expose a single frame of film. When you project all those frames at running speed, they combine to create motion, just like any footage that had been shot ‘normally’ at running speed.

On current video cameras, this is not usually possible, however the very same thing can be achieved with the appropriate video editing software and computer. Video editing software can select single frames from video captured with a video camera. When those frames are played back at full running speed, the end result is motion, just like with the older movie camera. The technique is the same, each frame is recorded to the hard drive of your computer instead of to a frame of movie film.

Software created for “stop motion” animation literally, through a series of stopped motion, creates the illusion of movement. There are currently several software applications available that provide stop motion capture. Existing stop motion software products are either too complex or too simple to make them useful to the general, non-professional public.

For example, “pencil testing” applications are commonly used in the animation industry to test the quality of movements of a plurality of sketches or images. These pencil testing applications are quite simplistic. They only allow for assembly and playback of images and do not offer any other functions.

Existing stop motion software that is directed to the general consumer, or for teaching purposes, also requires the use of additional software to create original audio. Completing an animation short including: title, animation, sound effects, and depending on the story, voiceovers and background music, within one stop motion animation software application is not possible with any existing products on the market.

Therefore, it is desired to have a single software application that provides all the functions for creating a stop motion animation in an easy to use environment suitable for use by non-professional users across a wide age range.

### SUMMARY

The present disclosure therefore provides a complete software application for creating stop motion animations, including capture, sequencing, and playback of single frame images, in addition to the ability to record voice and music, and insert audio such as sound tracks and sound effects. The stop motion animation application of the present disclosure is the only complete, easy-to-use tool for creating and teaching stop-motion animation that is available on a wide variety of platforms, including PC, Mac, web browsers, cellular phones and other mobile computer devices.

The present disclosure furthermore provides a system and method for teaching animation principles in an effective way. The present disclosure in not simply a stop motion capture tool. It is a teaching environment, for both students and instructors.

The stop motion animation application is designed to allow users to create digital stop-motion animations by capturing single frame images from an image capture device such as a digital camera or web cam, and sequencing the images together to play back as an animation. Images are captured and played back in sequential order. Editing function are provided such as deleting individual frames and re-sequencing frames. The user can opt to record audio (via Mic/Line-In) and/or insert sound effects and music accompaniment to play along with the animation. When finished, the final output showcases the user's custom movie with a video source and custom audio synced to the playback. These custom movies will play back at a constant frame rate of 12 frames per second, and can be exported to a QuickTime movie file to be viewed outside the application.

In an exemplary embodiment, the stop motion capture application includes three modes: capture, playback, and audio. In capture mode, the video feed from the image capture device is displayed, and the user can capture frames for his or her animation. In playback mode, the user can playback the captured frames in sequence and view them as an animation.

In audio mode, the user is provided with the ability to add audio such as music, voice-overs, sound effects, etc to their animation. The stop motion capture software of the present disclosure provides an audio mode that allows users to record directly into the software, without having to use professional editing tools. Other stop motion capture products require users to import sound from other programs. The software application of the present disclosure is the only stop motion capture tool that allows a user to make a completed movie beginning with single frame capture and progressing to insertion of audio, either through recording music, sound effects, or voice, or using the tool's existing music and sound effects.

The application allows multiple users to collaborate together in creating animation projects. An import feature can be used to combine several animations together. This feature also assists the user in resolving problems that might arise with missing movie resources, such as audio files.

The present disclosure further incorporates a classroom management feature, which includes organizational and search functions that allow animation instructors to efficiently manage classrooms and student user accounts. The classroom management feature is also a teacher's administrator tool intended to be used by animation instructors to better manage the students, classroom, and hardware.

The present disclosure is therefore applicable for use both at home or in a classroom setting.

The stop motion capture software in accordance with the present disclosure was inspired by experience teaching a proprietary visual art and animation curriculum to students ages 5 through 18. The curriculum was designed to teach on a step-by-step learning gradient that builds knowledge over time starting with a good foundation. Using the curriculum, students easily evolve through a system of lessons to build confidence and competence as they progress from basic fundamentals to advanced techniques.

The design of the software application of the present disclosure is based on the same step-by-step method, making the tool simple enough for a kindergarten classroom while at the same time able to satisfy the demands of experimental older students. The software application of the present disclosure is a creativity tool for the novice regardless of age.

### BRIEF DESCRIPTION OF THE DRAWINGS

FIG. 1 is a block flow diagram of an exemplary embodiment of the stop motion application.

FIG. 2 is an exemplary screen shot of capture mode.

FIG. 3 is an exemplary screen shot of playback mode.

FIGS. 4a-4e are exemplary screen shots of audio mode.

### DETAILED DESCRIPTION

In the following description of the present invention, reference is made to the accompanying drawings which form a part thereof, and in which is shown by way of illustration, exemplary embodiments illustrating the principles of the present disclosure and how it may be practiced. It is to be understood that other embodiments may be utilized and structural and functional changes may be made thereto without departing from the scope of the present disclosure.

The stop motion animation tool utilizes principles used by animation instructors to educate principles of animation and to enable a user to create a complete stop motion animation. The present disclosure is designed to empower users to learn the basics of animation while providing a tool robust enough to create more advanced animation. The present disclosure is designed to be simple enough for a kindergarten classroom to use, while at the same time satisfying more experimental older students.

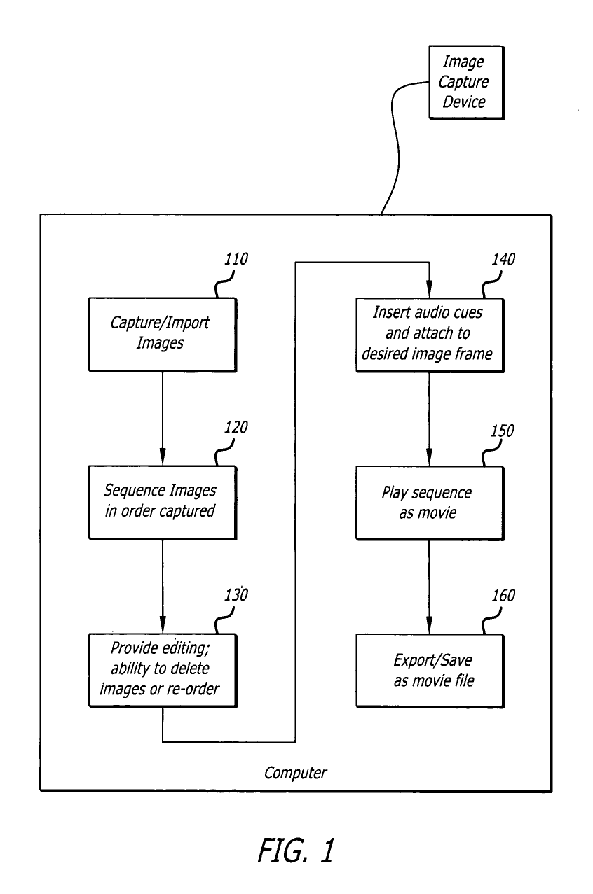

FIG. 1 is a block flow diagram of an exemplary embodiment of the stop motion application. The application is designed to allow users to create digital stop motion animations by capturing single frame images from an image capture device to play back as animation. Images can be captured, for example, from a digital camera or a web camera attached to the computer. A computer is considered any device comprising a processor, memory, display, and appropriate user input device (such as mouse, keyboard, etc). Images are captured and played back in sequential order. The user can record audio (via Mic/Line-in) and/or insert sound effects and music accompaniment to play along with the animation. When finished, the final output plays back the user's custom movie with custom audio synced to the playback. The custom movies generally play back at a user defined frame rate. For example, a default frame rate of 12 frames per second may be used.

The animation or movie can then be exported into a number of different video or movie file formats for viewing outside of the software application of the present disclosure. For example, movies may be exported as QuickTime, Windows Media Player, Real Video, AVI, or MPEG movies. It should be understood that there are numerous other types of movie files that could be used.

The present disclosure is a powerful stop motion tool that makes creating animation quick and easy.

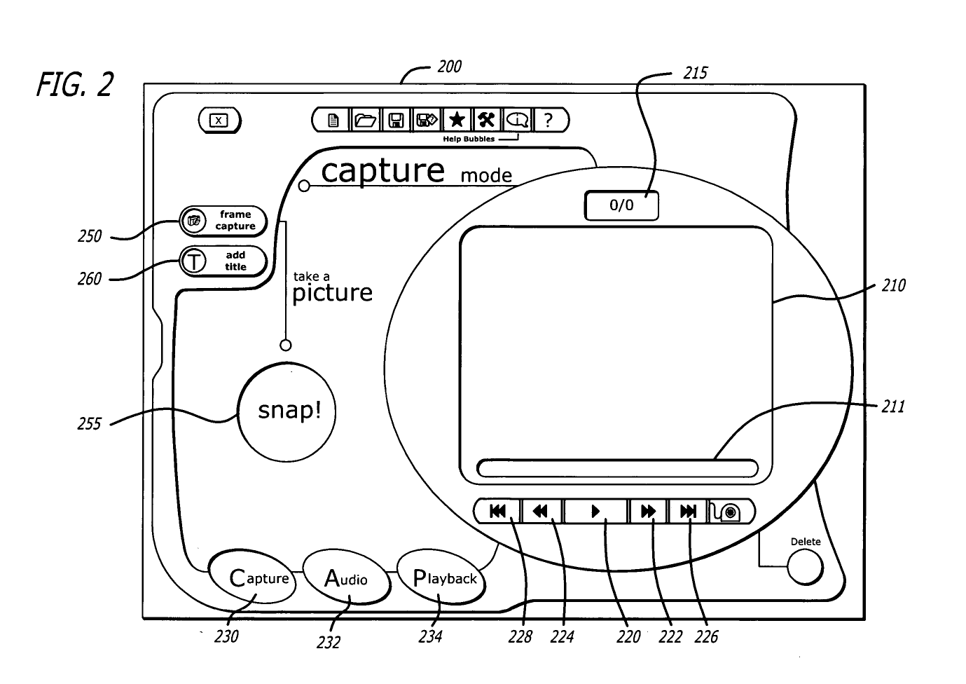

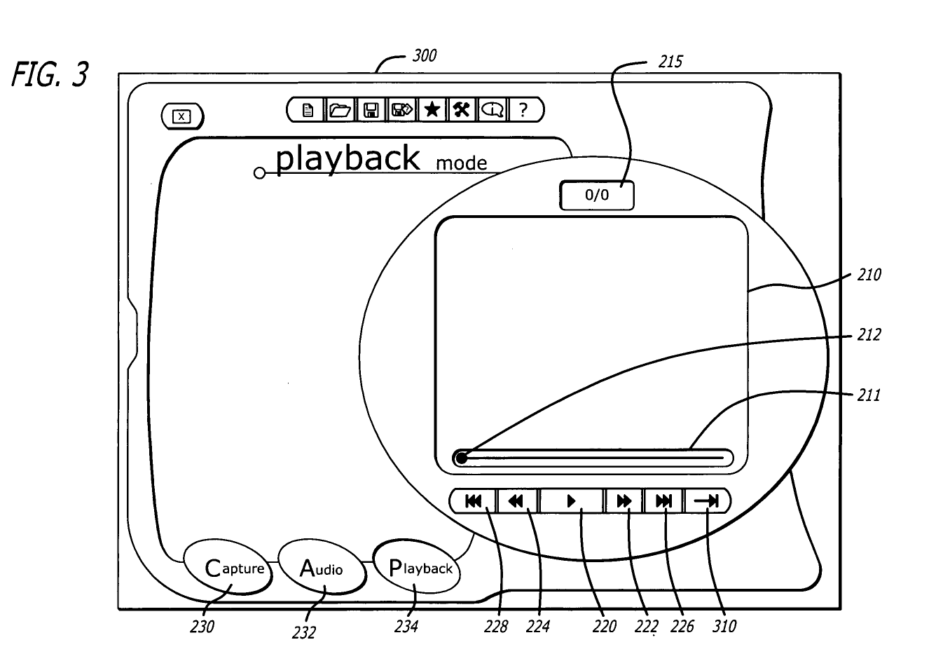

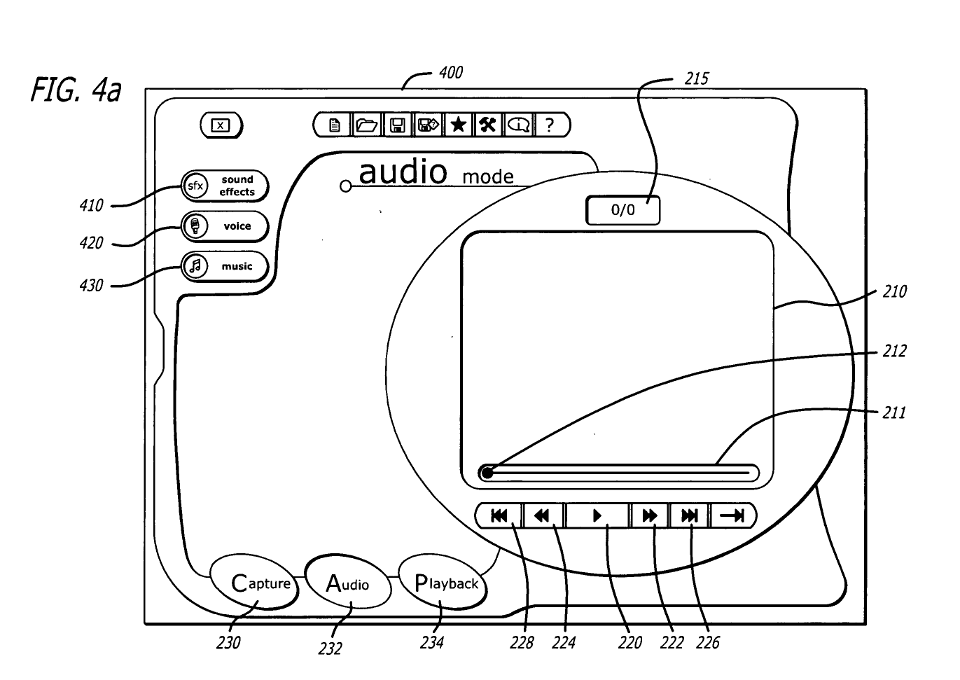

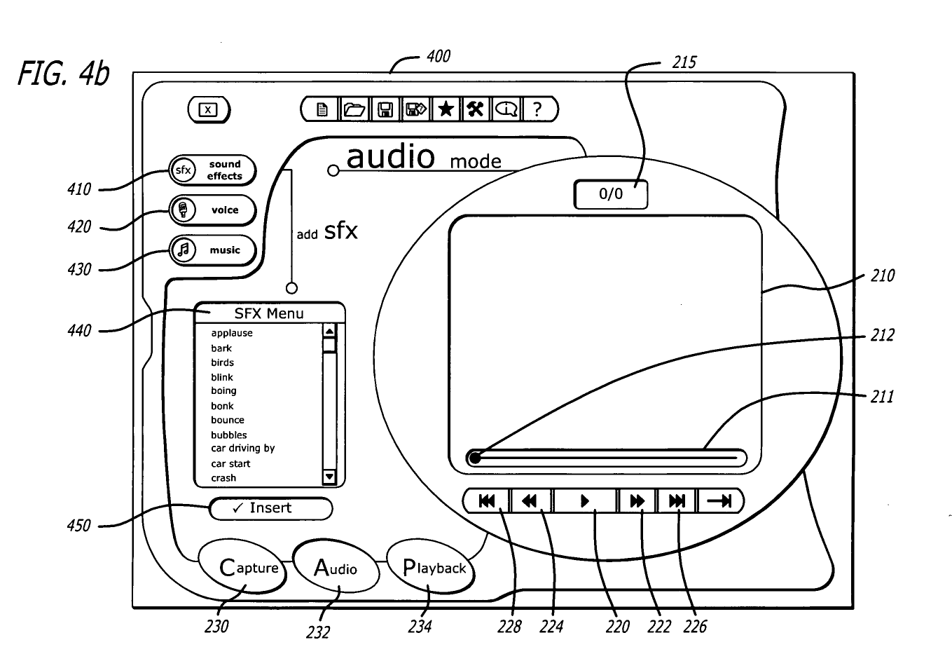

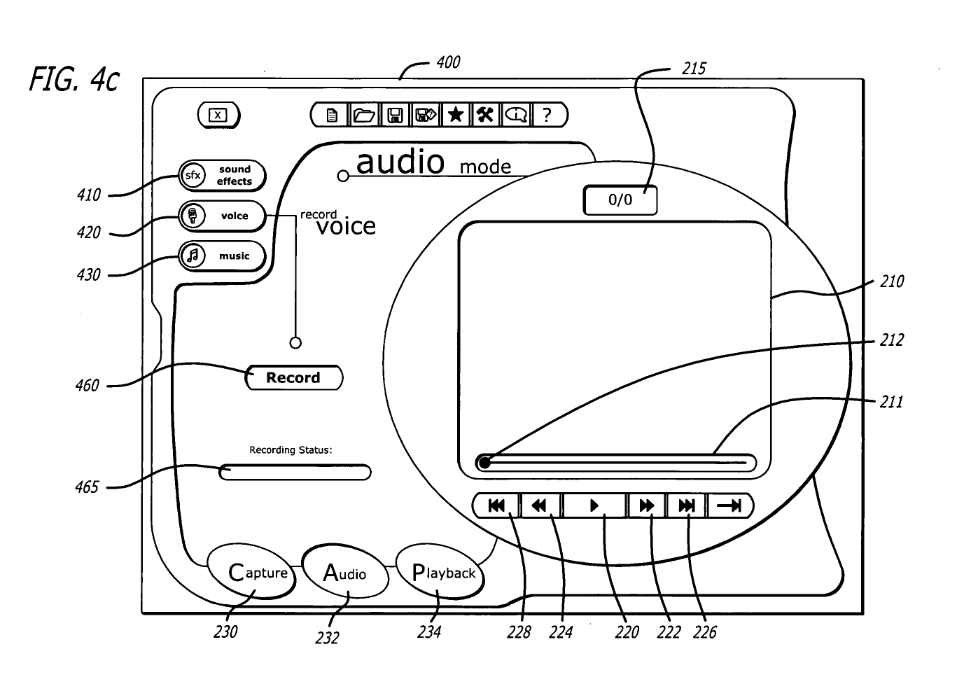

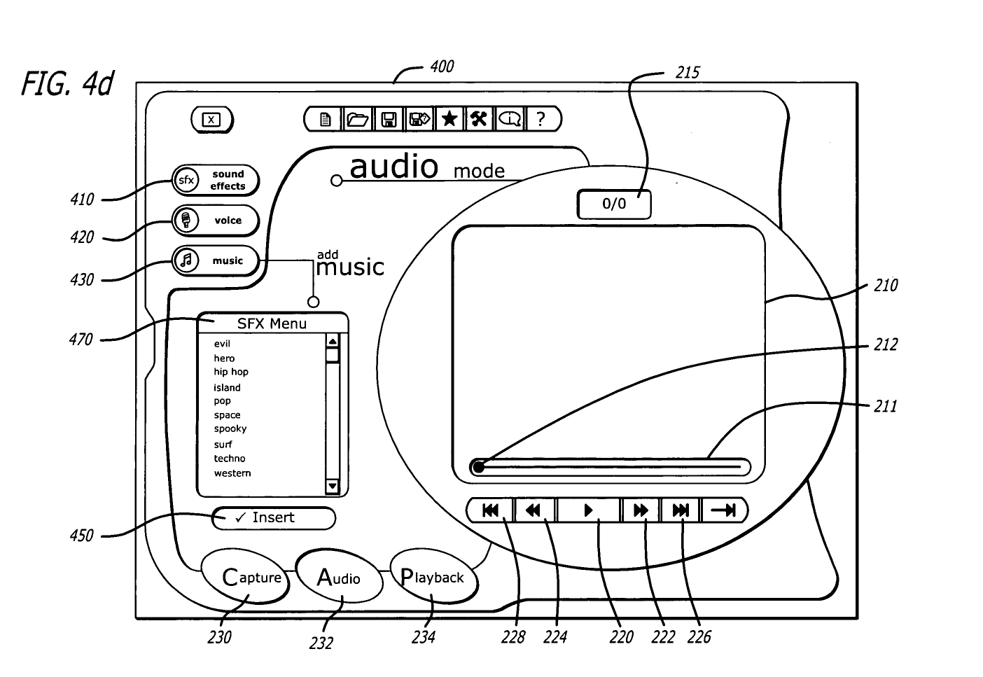

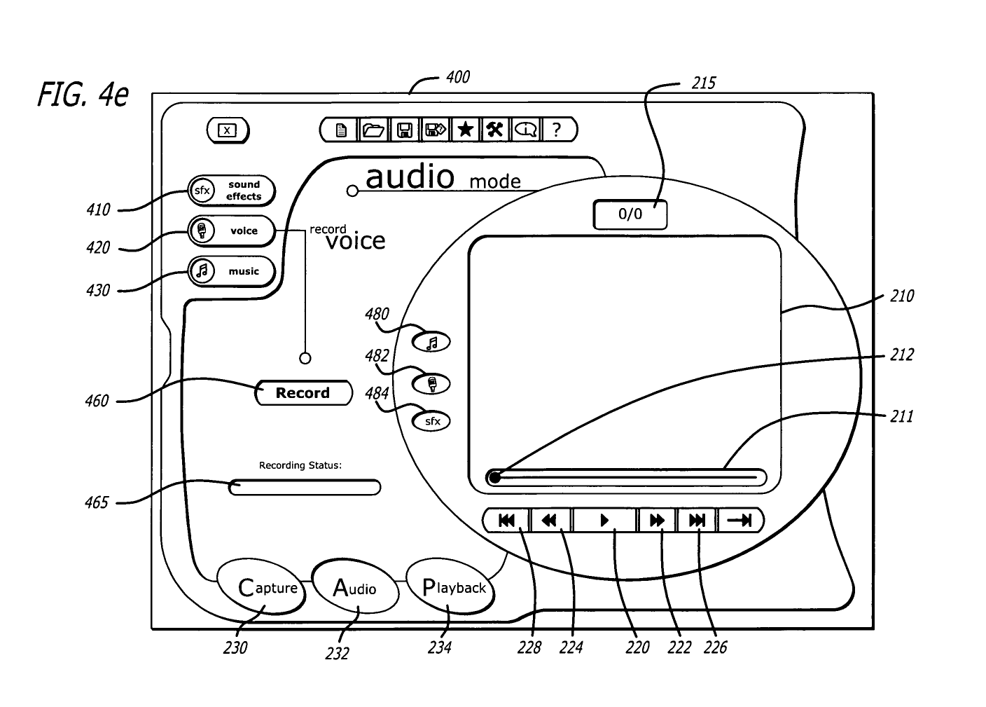

In an exemplary embodiment, the stop motion capture application includes three modes: capture, playback, and audio. FIG. 2 illustrates an exemplary screen shot of capture mode 200. In capture mode, the video feed from the image capture device is displayed, and the user can capture frames for his or her animation. FIG. 3 illustrates an exemplary screen shot of playback mode 300. In playback mode, the user can playback the captured frames in sequence and view them as an animation. FIGS. 4a-4d illustrate exemplary screen shots of audio mode 400. In audio mode, the user is provided with the ability to add audio such as music, voice-overs, sound effects, etc to their animation.

Within each of the modes, there are further functionalities that allow the user to access a specific aspect of one of the main modes. For example, sub-modes available within capture mode include frame capture and adding a title. Sub-modes available in audio mode include, for example, adding voice, music, and sound effects.

However, there are a series of features that are not exclusive to any one mode, but instead are shared by all modes within the stop motion capture application. These features, or common user interface elements, are accessible at all times from all modes. Furthermore, unlike other mode-specific features throughout the application, their functionality remains consistent throughout all modes as well. The common user interface elements of the stop motion animation software are now described.

Common User Interface Elements

As is shown in each of FIGS. 2-4, display window (210) is present in each mode of the application. Generally, this is the area in which images are displayed in the application. However, the content within display window (210) changes depending on the mode that is selected. For example, in capture mode, the display window (210) displays the live feed that is being received from the selected video input device. In playback mode, the display window (210) displays the frames that have been captured by the user. Frames are displayed sequentially as a movie (when play is accessed) or individually on a frame-by-frame basis (using the back frame, forward frame, fast back, or fast forward buttons). In audio mode, the display window (210) displays the frames that have been captured by the user. Frames are displayed sequentially as the user's movie so that audio can either be recorded during the visual playback or inserted via the music or sound effect menus.

The user interface of the stop motion animation software further includes a frame slider bar (211) which allows the user to quickly navigate through captured frames. The frame slider bar comprises a slider (212) that is used to scroll through the frames., The user clicks and drag the slider (while still holding down the mouse button) to the desired location on the timeline, and then releases the mouse button. Once released, the display window updates to reveal the frame that is currently selected.

In one embodiment, the frame slider bar (211) is located within the display window (210), however the frame slider bar may be located wherever is most convenient in the user interface. Generally, in order to use the frame slider bar, the user must have at least two frames captured so there is something to scroll between. Therefore, in one embodiment, having less than two frames renders this control inoperable.

Another common user interface element is the frame counter (215) which is located above the display window in each of FIGS. 2-4. The frame counter is a numeric representation of the frame that the user is currently on or viewing. In an exemplary embodiment, as shown, the frame counter (215) also shows the total number of frames. For example, if the frame counter displays the numbers “12/100”, then “12” represents the number of the current frame while “100” represents the total number of frames. If there are no frames yet recorded, the both numbers will be zero (ex: 0/0).

Therefore, when the slider (212) in the frame slider bar (210) is being dragged back and forth across the timeline, the frame counter (215) updates to correspond to the current location in the frame sequence. In some embodiments, this action causes the display window (210) to visually scroll through each frame. In other embodiments, dragging the slider (212) only displays the frame numbers in the frame counter (215) and does not display each of the corresponding frames within the display window (210). However, when the slider (212) is released, the frame image is updated in the display window (210).

Also, when viewing a movie in playback or audio modes, the left number within the frame counter (215) increases as the frames advance. Similarly, the left number adjusts accordingly when the user uses the fast forward, fast back, forward frame, and back frame buttons.

Below the display window (210) are a plurality of buttons that assist the user in viewing and controlling playback of images. As is illustrated in FIGS. 2-4, in an exemplary embodiment, there are buttons for play (220), forward frame (222), back frame (224), fast forward (226), and fast back (228). For example, play button (220) allows the user to playback the sequence of images that have been captured. The forward frame button (222) allows the user to advance to the next frame each time the button is clicked. Similarly, the back frame button (224) allows the user to move back to the previous frame each time the button is clicked. The fast forward button (226) allows the user to quickly advance to the last frame. The fast back button (228) allows the user to quickly go back to the first frame.

In one embodiment, the play button (220) is a two-state toggle button that has both play and pause functionalities. Pressing the play button a first time allows the user to start the playback of frames (starting at the currently selected frame) while clicking on the play button a second time allows the user to pause or stop the playback from continuing. Therefore, the visual state of the play/pause button generally shows the state that can be accessed once the button is clicked. For example, when the play icon is displayed, the playback is stopped. Clicking on the play button switches the button to pause and starts/restarts the playback.

The forward frame button (222) allows the user to step forward through the frame sequence one frame at a time. Similarly, the back frame button (224) allows the user to step backwards through the frame sequence one frame at a time. For example, when pressing the back frame button, the display window (210) refreshes to display the previous frame in the sequence, the frame slider (212) moves one notch to the left on the timeline, and the frame counter (215) regresses one frame as well (e.g., 10/10 to 9/10).

The forward and back frame buttons (222, 224) are generally only functional if there are frames that can be advanced or regressed to. For example, if you are on Frame 1 or no frames have even been captured, clicking on the back frame button does nothing. If accessed in capture mode when the live video feed is displayed, the captured frames will replace the live video feed in the display window. An exception is in capture mode when the user is on the last frame. In this case, clicking on forward frame will kick the live video feed back ON as well as toggle the live feed button to on. If accessed in capture mode when viewing the last captured frame in the sequence, the live video feed will replace the captured frames in the display window.

The fast forward button (226) allows the user to quickly advance to the very last frame without having to go frame-by-frame with the forward frame button. Once the fast forward button is selected, the display window refreshes to display the last frame, the frame slider (212) moves to the right-most position on the timeline, and the frame counter (215) advances to the last frame (e.g., 10/10). Similarly, the fast back button (228) allows the user to quickly rewind back to the very first frame (i.e., Frame 1) without having to go frame-by-frame with the back frame button. Once selected, the display window refreshes to display Frame 1, the frame slider (212) moves to the left-most position on the timeline, and the frame counter (215) rolls back to Frame 1 (e.g., 1/10). If accessed in capture mode when the live video feed is displayed, the captured frames will replace the live video feed in the display window.

In one embodiment, another common user interface element provides the ability for the user to easily switch from one mode to another. For example, three mode switch buttons 230, 232, and 234 (Capture, Audio, and Playback) are provided to easily switch between modes. The mode switch buttons not only allow the user to easily switch to another mode, but also provide a visual indicator showing which mode the user is currently in.

Functionalities and features specific to each of the modes are now described in more detail.

Capture Mode

An exemplary screen shot of a stop motion animation application in accordance with the present disclosure is shown in FIG. 2.

In one embodiment, when the application is launched, capture mode (200) appears by default since capturing images is the logical first step in creating an animation or movie. In capture mode, the display window (210) displays either the live video feed or the user's captured frames.

The stop motion animation software is designed to capture images from an image capture device such as a digital camera, web camera, video camera, or other image source. Images can also be imported into the application by downloading from the Internet, or even by capturing images through a device located remotely but connectable via the Internet, such as a remote web camera. In general, images can be imported from any image file. In exemplary embodiments, the application includes drivers for common camera devices such that the application can easily recognize most image capture devices without prompting the user to install additional support.

The frame capture button (250) allows the user to launch frame capture functionality, and more specifically, to access the frame capture “snap!” button (255) so that the user can capture frames for his/her animation. In an exemplary embodiment, once the frame capture button (250) is selected, the camera's live feed turns on and is displayed in the display window (210). The live feed of the image capture device refers to what is seen through the lens of the camera. A graphic may appear prompting the user to take a picture by pressing the large “Snap!” button (255). The user is now ready to start taking pictures.

The “Snap!” button (255) allows the user to capture images from a supported image capture device and import the images into the software application. Once images are captured, these images become frames, which in turn become the basis for the user's animation or movie.

When the “snap!” button (255) is pressed, a single image is recorded from the image capture device and stored in memory as a frame. As this happens, the frame counter (215) advances by 1 (ex: 3/3 becomes 4/4), and the frame slider bar (212) moves to the right appropriately. If this is the first frame captured in a new project file, this frame becomes Frame 1 (e.g., 1/1 on the frame counter). If it is not the first frame captured in a new project file, this frame is added to the end of the frame sequence. For example, if there were already 10 frames captured, the currently captured image becomes Frame 11 (e.g., 11/11 on the frame counter).

In one embodiment, when a frame is captured, the application freezes for a few (2-3) seconds, and then returns to the live video feed display. This helps reinforce to the user which image has been captured.

To add additional frames, the user can continue to click on the “Snap!” button (255) as many times as desired. Each frame will be added after the one before and the frame counter (215) and frame slider (212) advances accordingly.

Capture mode also provides the functionality of adding a title to an animation. The add title button (260) allows the user to access the “Add Title Snap!” button so the user can capture a title frame for his/her animation. The “Snap!” button allows the user to capture an image/frame from the video input device and use it as the movie's “opening shot”. This can be done at any time during the movie creation process.

If a title frame has not yet been recorded for the current project: Once selected, a single image is recorded from the camera and stored as the title frame. As this happens, the frame counter (215) advances 1, and the frame slider bar (211) advances accordingly. However, unlike frame capture's “Snap!” button, where the frame gets added to the end of the frame sequence, the title frame gets added to the beginning. As a result, all frames get “pushed” forward 1 frame once a title frame is captured (e.g., the title frame becomes Frame 1, the previous Frame 1 becomes Frame 2, and so on).

Though it is merely a single frame, the title frame is displayed/held for 5 seconds (i.e., the equivalent of 60 captured frames when played back on 12 fps) during playback. This “frame hold” is designed to give the effect of a opening credits/title shot without making the user have to physically create 60 frames to accomplish the same effect.

In one embodiment, adding a title in the present application is limited to merely taking a snapshot of text (or any other image, for that matter) that the user has created outside of the application. In other embodiments, the user can create a title via typing in text.

Taking the place of the loop button in capture mode, the live feed button allows the user to re-initiate the live video feed when viewing captured frames. In addition, this toggle button also serves as an indicator of sorts, showing whether or not the live feed is active.

In capture mode, the delete button allows the user to get rid of any unwanted frames, and indirectly, any audio cues and user-created audio snippets that are tied to them. The delete button is only available when the user has first switched from the live feed and navigated back to a captured frame (by using the playback controls). When no frames have been captured OR the live feed is displayed, the delete button is inactive, and is visually grayed out.

In one embodiment, a delete warning option is provided. Therefore, once the delete button is selected, a dialogue window appears asking the user to confirm the desired deletion. With this dialogue, there will be two (2) iconic buttons (“Cancel” and “OK”) that allow the user to exercise his/her choice. If the user selects the “Cancel” option, then the prompt window closes, and the user is taken back to the program state prior to the delete button being selected (i.e., the last frame is replaced by the live video feed). The frame has not been deleted. However, if the user selects the “OK” option, then the prompt window closes, the current frame is deleted, and the frame slider bar (212) and frame counter (215) update accordingly (i.e., it subtracts 1 from both numbers).

Delete removes the frame currently displayed. In addition, frames can only be deleted one unit at a time; there is no “batch” delete.

Frames or images in the application can have associated typed text. The text will be displayed during playback in authoring mode. It will also be exported with the movie. Each frame in an animation can also have an associated URL. When the project or exported movie is played back, a click on that frame will open a web browser that will take the user to the specified URL.

Playback Mode

FIG. 3 illustrates an exemplary embodiment of the user interface of playback mode (300). Playback mode allows the user to see how his/her animation looks at anytime during the creative process. Considered the “safe” mode since no editing takes place here, playback mode (300) allows the user to preview all frames and recorded audio that have been captured/inserted thus far. Depending on the feature used, the user is able to view each frame individually or as a complete movie. This mode is essential to the user as previewing tool, as this is where the final product will likely be viewed just prior to export. The following represents all functionality specific to this mode.

The loop button (310) allows the user to choose to either view the movie in a repeating loop or following a “one time through” approach. The loop button (310) has two visual states that can be toggled between on and off. When in the on position, the playback will continuously loop (i.e., the movie restarts from Frame 1 after the last frame has been reached) when play (220) is activated. When in the off position [default setting], the playback stops when it reaches the last frame. The loop button (310) can be toggled ON or OFF at any time in playback mode, including actual playback. For example, if looping is set to ON, and during playback, the user toggles the Loop button to OFF, the movie will stop playing when it reaches the last frame.

While, in some embodiments, capture mode (200) is the default mode or view for a new project, playback mode is the default mode or view for saved files that have just been opened. When opened, the project will be automatically rewound to Frame 1 and Frame 1's image is displayed in the video feed/playback area.

When playback mode is accessed via the mode switch button (234), the frame sequence gets reset back to Frame 1 (as does the Frame Counter), but the movie does not self-start. The user must click play (220) to start the movie playback.

Movies are generally played at a frame rate of 12 frames per second. However, the frame rate in the movie can be changed at any arbitrary point in the movie by changing the frame hold time in the animation data.

Audio Mode

FIGS. 4a-4e illustrate exemplary embodiments of the audio mode found in the stop motion animation application. Audio mode (400) allows the user to add synchronized audio to his/her movie by selecting from pre-recorded, supplied audio (e.g., music and sound effects) and/or recording his or her own audio through a microphone and the computer's microphone or line-in connection. In an exemplary embodiment, audio mode provides three categories of audio which may be inserted, including voice or other recorded audio, sound effects, and music. Buttons 410, 420, and 430 are provided for the user to easily choose between the different types of audio.

Because of the need to determine where to add audio and how long the audio should last, many of the functions and controls, e.g., play/pause (220), fast forward and back (226, 228), and forward and back frame (222, 224) found in playback and capture modes are also available in audio mode as well.

In general, audio is added and synchronized to an animation on a frame to frame basis. Audio is added to animations by inserting an audio cue at the desired frame within the animation. The audio cue indicates that audio should start playing at that frame. When an audio cue has been inserted in a frame, a visual indicator or icon appears next to the display window to indicate an audio cue is present. The user can click on the audio cue icon to preview the audio to be played by the audio cue or to easily delete the audio cue.

In one aspect, audio continues to play until the audio ends. In another aspect, audio may be looped to play continuously until the end of the animation. In yet another aspect, additional audio cues may be inserted at a later frame to indicate where the audio should end. Audio cues and the method of inserting and deleting audio cues is discussed in more detail below.

When an audio cue is assigned to a particular frame in audio mode, an iconic representation of that cue (one per cue type) appears above the display window next to the frame counter. This makes it easier to identify cues for future editing.

FIG. 4b illustrates an exemplary user interface for inserting sound effects within audio mode. The sound effects button (410) allows the user to insert sound effects into his or her movie. In an exemplary embodiment, the stop motion animation application includes a plurality of pre-programmed sound effects which are available to the user.

A sound effect menu (440) provides a list of available sound effects and allows the user to select and preview sound effects. In some embodiments, the user is further able to import additional sound effects into the application. For example, sound effects could be retrieved from the Internet and added to the list of available sound effects within the application. Alternatively, the user could record or create his or her own sound effects and import them into the application.

In an exemplary embodiment, when the user clicks on an audio file name within the sound effect menu (440), the sound effect's file name becomes highlighted, and the sound effect is played aloud. This allows the user to preview each of the different sound effects prior to inserting into the animation. In the case of certain sound effects that are relatively long in duration, only a portion of the sound effect will play for this preview.

Sound effects are added to the animation by attaching the sound effect to a specific frame using the insert button (450). The user uses the controls (e.g. play, forward and back frame) located beneath the display window to locate the desired frame where the sound effect should start playing. The user then presses the insert button (450) to attach the sound effect to the frame.

The voice button (420) allows the user to record his/her own audio clips through a microphone or line-in connection. FIG. 4c illustrates an exemplary screen shot of the user interface for recording audio and adding it to an animation. In one embodiment, once the voice button (420) is selected, a graphic appears prompting the user to record audio and the record button (460) and recording status window (465) appears. Providing that the user has a microphone or audio source connected via the mic/line-In, he/she is now ready to start recording audio to be used in his/her animation.

In one aspect, the record button (460) is a toggle button which has two states: record, and stop. The button shows the state that will be entered once it is pressed. Therefore, when the button reads “record”, recording is stopped. Similarly, during recording, the button reads “stop.” The user clicks on the record button when recording is complete to stop recording.

In one embodiment, once the record button (460) is selected, a “3-2-1” countdown is displayed and optionally a countdown sound effect plays for each number. This provides the user warning that recording is about to start. Just prior to following the “1”, the button changes from its “record” state to “stop”, the recording status window's text changes to “Recording”, and audio recording is initiated. Simultaneously, play (220) becomes auto-selected/engaged (i.e., it visually changes to its pause state), the frames begin playback starting from the current frame, all other playback controls (forward frame, back frame, fast forward, and fast back) become inactive, and the frame counter (215) begins to advance accordingly.

To stop recording, the user selects the record button (now in its “stop” state) again. When this occurs, the record button changes back to its unselected state (“record”), the recording ends, and the audio cue is associated with the frame displayed at the first frame of the recording sequence. Behind the scenes, the audio file will have been saved to the audio files folder under a name that is assigned by the program.

During recording, the user has the option of pausing audio recording (by pressing stop) if they need to take a break during recording. When the user is ready to resume recording, the user needs only to press the record button again, and the recording will pick up where he/she left off. Note: In this instance, separate audio files (and sound cues) will be created; the user is not adding onto the previous sound file. This “recording in pieces” technique is advantageous to the user as it allows them to easily find (and potentially delete) a particular piece of audio instead of having to delete everything and then start over from scratch. If the user attempts to change modes during audio recording, the recording is stopped immediately, but yet the clips are retained just as if the user pressed Stop first.

Generally, once recording has been initiated, recording continues until either the animation or sequence of frames has reached the last frame or the user has pressed stop. During recording, any already existing audio cues are muted. Once recording has stopped, audio cues are returned to their active/playable status. The recording status window (465) helps further identify whether or not recording is initiated. The recording status window indicates to the user when recording is in progress or when recording has been stopped.

In one embodiment, audio is recorded for a length of time that matches the time length of all the user's captured frames. Recorded audio having a length that exceeds the total length of the animation is discarded. For example, if the user has 10 seconds worth of frames but tries to record 20 seconds of audio, then only the first 10 seconds of audio is retained.

The music button (430) allows the user to add music accompaniment to his or her animation, and more specifically, to access the controls for adding custom music loops into his or her movie. FIG. 4d illustrates an exemplary embodiment of the user interface for adding music synchronized to an animation.

The music menu (470) allows the user to select and preview custom music loops from its directory. The music menu (470) comprises a list of music files that can be attached to specific frames within the animation by using the insert button (475). If the user clicks on an audio file name within the music menu, a snippet of the selected music loop is played aloud. In some embodiments, the user is further able to import additional music into the application. For example, any type of music file, such as an audio file in mp3 or wav format could be imported into the application and listed in the music menu.

In many cases, the length of the music track is not the same as the length of the animation. In such cases, music can be looped, if the length of the music is shorter than the length of the animation. Music looping is simulated by repeating music segments, and truncating one of the segments to match the length of the animation. If the length of the music is longer than the length of the animation, the music may be cut short.

Looping of music may be accomplished in a number of ways. Music looping may be done automatically by the program. For example, the program may simply repeat the same music track repeatedly, and truncate the last repetition to match the length of the animation. Alternatively, the user may be provided with options in determining how the music is looped. For example, the user may determine that only a portion of the music should be looped. In such a case, the user may be able to insert triggers which indicate where the portion starts and ends. The triggers may be in a visual format, or may be a time within the audio.

In some embodiments, music is automatically faded down towards the end of the animation. In other embodiments, the user is provided with options for how the audio should fade in or out.

The insert button (450) allows the user to assign sound effects or music to specific frames by attaching an audio cue to a specific frame. An audio cue triggers the associated audio to play when the corresponding frame is accessed during playback. If an audio file is selected and the insert button (450) is selected, the audio cue is added to the currently displayed frame, and an audio cue indicator button (480, 482, 484) appears next to the display window to indicate the cue assignment.

If the user tries to insert an audio cue on a frame that already has a cue, then the new cue simply replaces the previous one. An exception to this is a user-created audio file/cue. Should the user try to record an audio file over an existing one, a dialogue window appears explaining that he/she must first delete the existing one before a new one can be recorded/added.

Consisting of three indicator-type buttons, the audio cue indicator buttons represents the three different audio types: music (480), voice (482), and sound effects (484). The audio cue indicator buttons allow the user to view whether or not an audio file has been attached to a specific frame as well as preview or delete a specific sound from his/her movie.

When an audio cue indicator button is selected, a mini pop-up window appears with three buttons inside it: play, delete, and close window. The play button plays the audio file that it associated with the current frame. The delete button deletes the selected audio cue, and in the case of the user's recorded audio (voice), the audio file itself. The close window option closes the pop-up window.

Generally, clicking the audio cue indicator button's delete button deletes the audio cue, and not the actual music or sound effect file. Once deleted, the user can then add a new sound effect/music loop to that frame. However, for user-created audio, such as a voice recording, when the sound meter's delete button is selected, a delete warning dialogue window appears asking the user to confirm the desired deletion. Within this window, two iconic buttons (“Trash It” and “Cancel”) are displayed to help the user execute his/her choice. If the user selects the “Trash It” option, the selected cue and audio file are removed from the frame number, and the prompt window closes. If the user selects the “Cancel” option, then the prompt window closes, and the user is taken back to the previous view with the Play/Delete/Close Window pop-up displayed. The audio file and cue have not been deleted.

If the user inserts an audio cue for an audio file during a period where another audio file is playing, then the first audio piece gets interrupted/ceases to play as the next audio piece is triggered. For example, you assign a “Pow!” sound effect to start playing on Frame 10. Assuming that the sound effect lasts 20 frames, the audio should end on Frame 30. However, if another sound effect cue (e.g. “Boing!”) is inserted before Frame 30 (e.g., at say, Frame 20), then upon playback, “Pow!” stops playing at Frame 20 as “Boing!” is triggered.

If the user has added audio to his/her movie that extends beyond the time equivalent of the number of captured frames, the audio will be faded out over the last 2 frames. Specifically, the audio will fade by 50% on the second to last frame, and then 20% on the very last frame.

Other Features

Many other features and animation techniques may be included with the present application. For example, two images can be combined to create a single movie frame using a chroma-key composite technique. The user can select an area of the screen with the mouse to define a group of colors that will be replaced by pixels from the same location in another image. Subsequent colors that are selected will be added to the existing set of colors that are removed in creating composite images. The composite image process can be applied repeatedly, allowing an indefinite number of images to be combined. The composite image process can be applied to a series of images. The composite image operation can be undone in the case that the results are not satisfactory. The background colors can be reset at any time.

Shadow frames are used to apply a variety of techniques for guiding the animator. These techniques include rotoscoping, marker tracks, and animation paths. Shadow frames are images that are stored with the frames for a project, but are displayed selectively while creating the animation. The shadow frames are blended with the animation frames or (live video input) using and alpha-channel to create a composite image. Shadow frames will not appear in the exported movie. Shadow frames can be used as a teaching tool, allowing the instructor to make marks or comments to direct the student toward improved animation techniques. The marks and comments can be written text or drawn marks.

The time-lapsed capture feature allows the animator to capture images at user-specified intervals until a maximum time limit is reached. The user could, for example, capture images at 10-second intervals for a maximum of 60 seconds. In this example, a single click to initiate the capture sequence would produce six captured frames. This process can also be limited to a specified number of captured images.

Animations in the present application can be saved in a plurality of different formats. An animation in progress may be saved in a plurality of separate external files or in one single file. In one aspect, the animation is saved as a Macromedia Director text cast member. Alternatively, animations can be saved as Synchronized Multimedia Integration Language (SMIL) or in Multimedia Messaging Service (MMS) format.

In another aspect, the animation may be saved as a collection of image data. For example, the application may save image data in a format comprising a text file, a plurality of image files, and one or more audio files. The text file comprises control data instructing the application how the plurality of captured images and audio should be constructed in order to create and display the animation. For example, the text file comprises control data representing each of the audio cues. This may include a reference to the audio file to be played, and the frame number at which the audio file should start playing.

The text file may also contain information about each of the frames within the animation. Alternatively, the text file may contain information about only selected frames, such as only the frames that contain audio cues. The text file may contain control data that include references to images, audio or other data that can be stored externally or within the project data file.

In another embodiment, the data is associated with each of the plurality of images as metadata. For example, audio queues associated with an image or frame.

In another aspect, the animation may be converted to a single video or movie file format. The animation can be exported into a number of different video or movie file formats for viewing outside of the software application of the present disclosure. For example, movies may be exported as QuickTime, Windows Media Player, Real Video, AVI, or MPEG movies. It should be understood that there are numerous other types of movie files that could be used.

Classroom Management Features

Furthermore, the present disclosure offers classroom management features. Instructors may create instructor accounts to manage their classroom and students. For example, a single computer may exist in a classroom, library, etc. that is dedicated to run the application in accordance with the present disclosure. More than one instructor may use the computer. Therefore, each instructor sets up an account for their class. All files that are saved during the instructor's login will be stored in a directory associated with the instructor's account. When the instructor leaves, they log out for the next instructor to login.

Within each instructor's account, students are able to create student accounts. Student work is likewise saved to a directory associated with the student's account. This further prevents one student from editing or removing another students' project.

Other classroom management features include the ability to view statistics on classroom or student usage.

Furthermore, the present disclosure offers storage monitoring features such as deletion reminders for clearing old files over a semester old, or storage capacity reminders, including early warnings of hard drive maximums.

Classroom management features will allow teachers to control the way groups of students share resources for group collaboration. A suite of management utilities is available that will allow the administrator to modify both project and configuration data for individuals or groups of users on a local-area network or web server.

In one embodiment, the stop motion animation software of the present disclosure is designed to run on a computer such as a personal computer running a Windows, Mac, or Unix/Linux based operating system. However, it is anticipated that the present application could be run on any hardware device comprising processing means and memory.

For example, the present application could be implemented on handheld devices such as personal digital assistants (PDA) and mobile telephones. Many PDA's and mobile telephones include digital cameras, or are easily connectable to image capture devices. PDA's and mobile telephones are continuing to advance processing and memory capabilities, and it is foreseen that the present stop motion animation software could be implemented on such a platform.

Furthermore, animations/movies created on using a mobile phone can be transmitted directly to another phone or mobile device from directly within the mobile application. Movies can also be sent to mobile devices from the a PC/Mac version of the present application or from a web-based version of the application. Movies can be transmitted over existing wireless carriers, Bluetooth, WiFi (IEEE 802.11) or any other available data transmission protocols. A variety of protocols, including SMILL, MMS and 3GPP may be used by the application to ensure compatibility across a wide spectrum of mobile devices.

In another embodiment, the stop motion animation application can be implemented to run on a web server, and is further used to facilitate collaborative projects and sharing exported animations/movies across various platforms. For example, a movie created on a PC installation could be exported and sent to a mobile phone. The web based version of the application uses HTTP, FTP and WAP protocols to allow access by web browsers and mobile devices.

In another embodiment, other applications can be accessed directly from within the present application to import data for use in creating an animation. For example, images created using an Image program can be added directly to an animation in the present application.

In another embodiment, the present application is implemented on a gaming platform. Common examples of gaming platforms include, but are not limited to, Sony PlayStation, Xbox, and the Nintendo GameCube.

The foregoing description of the preferred embodiments of the invention has been presented for the purposes of illustration and description. It is not intended to be exhaustive or to limit the invention to the precise form disclosed. Many modifications and variations are possible in light of the above teaching.

1. A method of creating an animation using a computer, comprising:
communicating with an image capture device and displaying an input from the image capture device in a display window;
capturing a plurality of images from the image capture device;
providing the plurality of images in the order they were captured to the display window for viewing by a user;
providing a user interface whereby the sequence of the images are capable of being edited, wherein editing comprises deleting an image and inserting additional images;
providing the ability to insert and synchronize audio to the sequence of images by attaching an audio cue to the image where the audio is to begin;
providing playback of the sequence of images as an animation;
and saving the plurality of images along with the audio as a video file.

2. The method of claim 1 wherein the communicating with communicate with the image capture device through a USB connection.

3. The method of claim 1 wherein the software program is configured to communicate with the image capture device through a FireWire connection.

4. The method of claim 1 wherein the image capture device is a web cam.

5. The method of claim 1 wherein the image capture device is a digital camera.

6. The method of claim 1 wherein the image capture device Is a video camera capable of capturing still images.

7. The method of claim 1 wherein the audio is music.

8. The method of claim 1 wherein the source of the image capture device is what is seen from the lens of the image capture device.

9. The method of claim 1 wherein the audio is a sound effect.

10. The method of claim 1 wherein the audio is recorded from a microphone.

11. The method of claim 1 wherein the audio file is a wav file.

12. The method of claim 1 wherein the video file is an aif file.

13. The method of claim 1 wherein the video file is a Quicktime movie.

14. The method of claim 1 wherein the input from the image capture device is the live feed.

15. The method of claim 1 wherein the input from the image capture device is what is seen through the lens of the image capture device.

16. A computerized stop motion animation application comprising:
an image capture mode configured to communicate with an image capture device and display the live feed of the image capture device on a display for viewing by a user, and further configured to capture a plurality of images from said image capture device and assemble/arrange said plurality of images in the order the images were captured as a sequence of images;
a playback mode configured to display the sequence of images to the user and to compile the sequence of images and play the images in order as an animation; and
an audio mode configured to add audio and synchronizing the audio to the sequence of images.

17. The computerized stop motion animation application of claim 16 wherein the image capture mode communicates with the image capture device through a USB connection.

18. The computerized stop motion animation application of claim 16 wherein the image capture mode communicates with the image capture device through a FireWire connection.

19. The computerized stop motion animation application of claim 16 wherein the image capture device is a web cam.

20. The computerized stop motion animation application of claim 16 wherein the image capture device is a digital camera.

21. The computerized stop motion animation application of claim 16 wherein the image capture device Is a video camera capable of capturing still images.

22. The computerized stop motion animation application of claim 16 wherein the audio is music.

23. The computerized stop motion animation application of claim 16 wherein the audio is a sound effect.

24. The computerized stop motion animation application of claim 16 wherein the audio is recorded from a microphone.

25. The computerized stop motion animation application of claim 16 wherein the audio is synchronized with the sequence of images.

26. The method of claim 1 wherein the audio is synchronized to the sequence of images by inserting an audio cue.

27. The method of claim 1 wherein the data representing the audio cue is saved in a text file.

28. The method of claim 1 wherein audio is synchronized by frame number.

29. The method of claim 1 wherein the computer is a mobile telephone.

30. A computerized method of creating an animation, comprising:
providing a user interface with a set of common user interface elements, the common user interface elements providing similar functionality in a plurality of different application modes and comprising a display window for viewing a plurality of single frame images and wherein the display window also displays the plurality of single frame images as an animation, a frame slider bar for navigating through the plurality of single, frame images, a frame counter indicating the number of the single frame image being displayed and the total number of single frame images in the animation, a play button for playing the animation, a forward frame button for advancing ahead by a single frame image, and a back frame button for reversing by a single frame image; and
providing a mode within the user interface with the ability to add audio by inserting an audio cue at one of the plurality of single frame images where audio is desired to start.

31. A method of creating an animation using a computer, comprising:
capturing a plurality of images by importing the plurality of images from a memory;
providing the plurality of images in the order they were captured to the display window for viewing by a user;
providing a user interface whereby the sequence of the images are capable of being edited, wherein editing comprises deleting an image and inserting additional images;
providing the ability to insert and synchronize audio to the sequence of images by attaching an audio cue to the image where in the audio is to begin;
providing playback of the sequence of images as an animation;
and saving the plurality of images along with the audio as a video file.

32. A method of creating an animation using a mobile telephone, comprising:
displaying an input from a image capture device on a mobile telephone display;
capturing a plurality of images from the image capture device;
providing the plurality of images in the order they were captured to the mobile telephone display for viewing by a user;
providing a user interface whereby the sequence of the images are capable of being edited, wherein editing comprises deleting an image and inserting additional images;
providing the ability to insert and synchronize audio to the sequence of images by attaching an audio cue to the image where in the audio is to begin;
providing playback of the sequence of images as an animation; and
saving the plurality of images along with the audio as a video file.

33. The method of claim 32 wherein the mobile telephone includes an image capture device.

34. The method of claim 33 wherein the image capture device is a digital camera.

35. The method of claim 33 wherein the mobile telephone is a camera phone.

36. A comprehensive tool for creating and teaching a stop motion animation, the tool being operable on multiple platforms, the tool comprising software configured to:
communicate with an image capture device and displaying an input from the image capture device in a display window;
capture a plurality of images from the image capture device;
provide the plurality of images in the order they were captured to the display window for viewing by a user;
provide a user interface whereby the sequence of the images are capable of being edited, wherein editing comprises deleting an image and inserting additional images;
provide the ability to insert and synchronize audio to the sequence of images by attaching an audio cue to the image where the audio is to begin;
provide playback of the sequence of images as an animation; and
save the plurality of images along with the audio as a video file.

37. The comprehensive tool of claim 36 wherein the platform is a personal computer running a windows based operating system.

38. The comprehensive tool of claim 36 wherein the platform is a personal computer running a mac based operating system.

39. The comprehensive tool of claim 36 wherein the platform is a mobile telephone.

40. The comprehensive tool of claim 36 wherein the platform is a handheld device.

41. The comprehensive tool of claim 36 wherein the platform is a video game system.
